(19) United States
(12) Patent Application Publication
(10) Pub. No.: US 2026/0179194 A1
(43) Pub. Date: Jun. 25, 2026

(54) DEVICES TO PERFORM VIDEO STREAM TRANSFORMATIONS

(71) Applicant: Hewlett-Packard Development Company, L.P., Spring, TX (US)

(72) Inventors: Andre da Fonte Lopes da Silva, Palo Alto, CA (US); Carol Tatsuko Ozaki, Palo Alto, CA (US)

(73) Assignee: Hewlett-Packard Development Company, L.P., Spring, TX (US)

(21) Appl. No.: 19/123,159

(22) PCT Filed: Oct. 31, 2022
(86) PCT No.: PCT/US2022/048490

§ 371 Date: Apr. 22, 2025

(51) Int. Cl. G06T 5/70

(52) U.S. Cl. CPC G06T 5/70; G06T 2207/10016

(57) ABSTRACT

An example non-transitory computer-readable medium includes instructions that, when executed by a processor, cause the processor to receive an indication of an applicable set of transformations for a video stream captured by a video-generating device, and compare the applicable set of transformations to a target set of transformations to be applied to the video stream to determine if a target transformation absent from the applicable set of transformations exists in the target set of transformations. When determining that the target transformation exists, the instructions transmit a request to the video-generating device to apply the target transformation. The instructions further receive the video stream from the video-generating device with the applicable set of transformations applied.

### BACKGROUND

Digital video capture and display may be performed by computing devices equipped with cameras and display devices. Transformations may be applied to a video stream to visually alter the video stream. Transformations may enhance video quality, increase privacy, add special effects, or apply other enhancements to a video stream.

### BRIEF DESCRIPTION OF THE FIGURES

FIG. 1 is a block diagram of an example non-transitory computer-readable medium with instructions to request that a video-generating device apply a target transformation that is absent from a set of transformations for a video stream generated by the video-generating device.

FIG. 2 is a block diagram of an example non-transitory computer-readable medium with instructions that apply, in response to a request, a target transformation that is absent from a set of transformations for a video stream.

FIG. 3 is a diagram of an example computer system to negotiate a set of transformations for video streams generated by video-generating devices.

FIG. 4 is a communications diagram of example communications between a video-controlling device and a video-generating device to conform applicable video-stream transformations to target transformations.

FIG. 5 is a block diagram of a device to communicate with a remote device to apply a target transformation to a video stream depending on an availability of the target transformation at the remote device.

### DETAILED DESCRIPTION

A transformation applied to a video stream may be inconsistent with what is expected. For example, it may be expected that a computing device that simultaneously displays multiple video streams does so with the same transformations. For example, all video streams may share a common background image, may share the same degree of background blurring, or may share another type and degree of transformation. In other examples, an expected transformation may be unavailable at the computing device that captures the video stream.

As will be discussed herein, a computing device in a video conference environment may be selected to perform a transformation on captured video. In some examples, a conference-room computer may perform any transformation that each endpoint computer does not or cannot perform, so that the conference-room computer may transmit and display the multiple endpoint videos in a consistent manner.

In various examples, two computing devices in a video conference negotiate which device will perform a given transformation on a video stream. It may be that one device has the capability to perform the transformation when the other device does not.

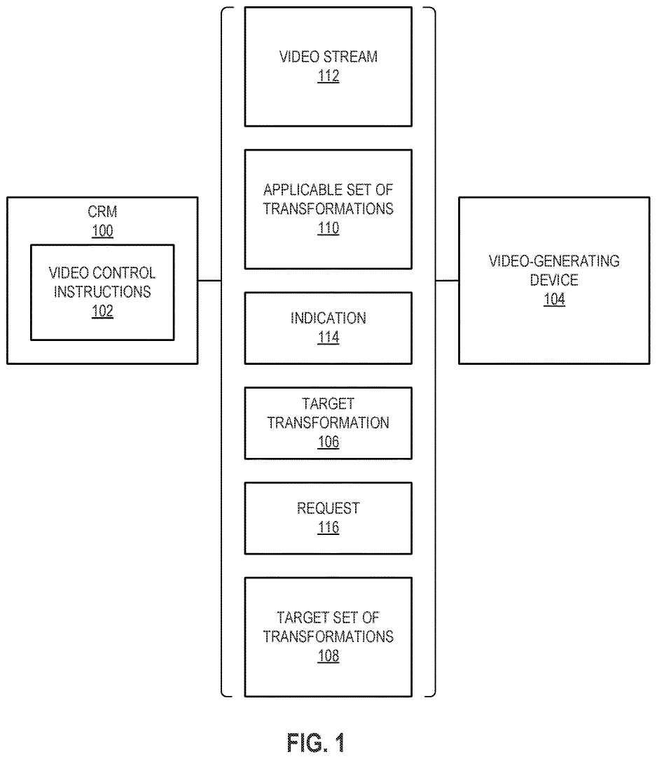

FIG. 1 shows an example non-transitory computer-readable medium 100 with video control instructions 102 to request that a video-generating device 104 apply a target transformation 106 that exists in a target set of transformations 108 and is absent from an applicable set of transformations 110 for a video stream 112 generated by the video-generating device 104.

The non-transitory machine-readable medium 100 may be provided to a computing device, such as a computer that controls a video conference environment (which may be termed a conference-room computer or meeting-room computer), a desktop computer, a notebook computer, an All-in-One (AiO) computer, a server, or the like. The computing device that includes the medium 100 and instructions 102 may also distribute video streams among multiple video-generating devices 104. The computing device that includes the medium 100 and instructions 102 may also play the video stream 112.

The non-transitory machine-readable medium 100 may include a non-volatile memory, such as read-only memory (ROM), electrically erasable programmable read-only memory (EEPROM), or flash memory. The medium 100 may include volatile memory, such as random-access memory (RAM). The medium 100 may include an electronic, magnetic, optical, or other physical storage device that encodes the instructions 102 that implement the functionality discussed herein.

A processor that executes the video control instructions 102 may include a microcontroller, a central processing unit (CPU), a field-programmable gate array (FPGA), an application-specific integrated circuit (ASIC), or a similar processing device.

The video control instructions 102 may be directly executable, such as binary or machine code, and/or may include interpretable code, bytecode, source code, or similar instructions that may undergo additional processing to be executed. All of such examples may be considered executable instructions.

The video-generating device 104 may be a computing device, such as a desktop computer, a notebook computer, an AiO computer, a tablet computer, a smartphone, a webcam, video camera, or the like. The video-generating device 104 may capture a video stream 112 locally and may receive and display a remote video stream.

The video-generating device 104 may be separate from the device that contains the non-transitory machine-readable medium 100. In such examples, the video-generating device 104 may communicate with the computing device that contains the medium 100 via a computer network. In other examples, the video-generating device 104 contains the medium 100 and the process discussed herein is internal to a single computing device.

The target set of transformations 108 includes any suitable number and type of transformations desired to be applied to the video stream 112.

The applicable set of transformations 110 includes any suitable number and type of transformations performed on the video stream 112. The applicable set of transformations 110 may be established prior to the video stream 112 starting and/or may be modified during the video stream 112.

Examples of transformations include auto framing, illumination correction, beautification, keystone correction, super resolution, background replacement, and background blur.

The video control instructions 102 receive an indication 114 of an applicable set of transformations 110 for a video stream 112 captured by a video-generating device 104. The indication 114 may include descriptors or other metadata that describe the transformations contained in the applicable set of transformations 110.

The video control instructions 102 compare the applicable set of transformations 110 to a target set of transformations 108 to be applied to the video stream 112 to determine if a target transformation 106 that is absent from the applicable set of transformations 110 exists in the target set of transformations 108. That is, the instructions 102 determine whether a desired target transformation 106 is missing from the set of transformations 110 that will be applied to the video stream 112.

When the video control instructions 102 determine that such a missing target transformation 106 exists, the instructions 102 transmit a request 116 to the video-generating device 104 to apply the target transformation 106. In effect, the missing target transformation 106 may be added to the applicable set of transformations 110.

The request 116 may include or be accompanied by a parameter for the target transformation 106. For example, a parameter may specify a degree of blurring for a background blur transformation.

The request 116 may include or be accompanied by data for the target transformation 106. For example, data may include a background image for a background replacement transformation that uses the background image.

The video control instructions 102 then receive the video stream 112 from the video-generating device 104 with the applicable set of transformations 110 applied. The applicable set of transformations 110 includes any target transformation 106 that is added as discussed above.

The video control instructions 102 may then distribute the received video stream 112 to other video-generating devices 104 participating in a video conference such as may be the case when the medium 100 is provided to a computing device that enables a video conference environment. Additionally or alternatively, the video control instructions 102 may initiate playback or continue to play the video stream 112 with the applicable set of transformations 110, such as may be the case when the medium 100 is provided to an endpoint (e.g., a video conference participant's computing device).

In this way a transformation may be added or removed from the applicable set of transformations 110, so that the video-generating device 104 applies a combination of transformations that is desired or expected by the computing device that contains the non-transitory machine-readable medium 100. The computing device that contains the medium 100 and executes the instructions 102 may thereby coordinate the processing of transformations among a group of video-generating devices 104. This may allow the computing device, for example, to distribute and/or composite multiple video streams 112 that have a consistent set of transformations.

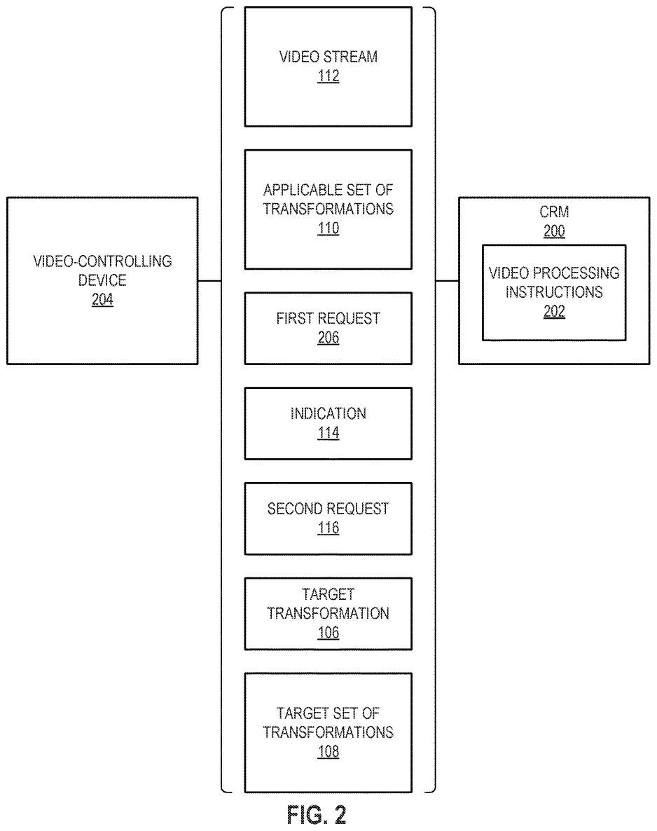

FIG. 2 shows an example non-transitory computer-readable medium 200 with video processing instructions 202 that apply, in response to a request, a target transformation 106 that is absent from a set of transformations 110 for a video stream 112.

The non-transitory machine-readable medium 200 may be provided to a computing device, such as a computer that captures and processes a video stream 112, such as a desktop computer, a notebook computer, an AiO computer, a tablet computer, a smartphone, a webcam, a video camera, or the like. The computing device that includes the medium 200 and instructions 202 may be in communication with a video-controlling device 204. The computing device that includes the medium 200 and instructions 202 may be used as the video-generating device 104 of FIG. 1.

The non-transitory machine-readable medium 200 may include a non-volatile memory, such as ROM, EEPROM, or flash memory. The medium 200 may include volatile memory, such as RAM. The medium 200 may include an electronic, magnetic, optical, or other physical storage device that encodes the instructions 202 that implement the functionality discussed herein.

A processor that executes the video processing instructions 202 may include a microcontroller, a CPU, a FPGA, an ASIC, or a similar processing device.

The video processing instructions 202 may be directly executable, such as binary or machine code, and/or may include interpretable code, bytecode, source code, or similar instructions that may undergo additional processing to be executed. All of such examples may be considered executable instructions.

The video processing instructions 202 capture a video stream 112. The instructions 202 may control a camera to capture the video stream 112. The instructions 202 may apply an applicable set of transformations 110 to the video stream 112.

The video processing instructions 202 may receive a first request 206 from the video-controlling device 204. The first request 206 may request identification of an applicable set of transformations 110 that is to be applied to the video stream 112.

In response to receiving the first request 206, the video processing instructions 202 transmit an indication 114 of the applicable set of transformations 110 to the video-controlling device 204. The indication 114 may include descriptors or other metadata that describe the transformations contained in the applicable set of transformations 110.

The video-controlling device 204 may compare the applicable set of transformations 110 to a target set of transformations 108 to determine whether a target transformation 106 is to be added to the applicable set of transformations 110. For example, the video-controlling device 204 may determine that a desired target transformation 106 is absent from the applicable set of transformations 110. The description above with respect to FIG. 1 may be referenced.

The video processing instructions 202 may receive a second request 116 from the video-controlling device 204. The second request 116 may request that a target transformation 106 be applied to the video stream 112.

The second request 116 may include or be accompanied by a parameter for the target transformation 106. For example, a parameter may specify a degree of blurring for a background blur transformation.

The second request 116 may include or be accompanied by data for the target transformation 106. For example, data may include a background image for a background replacement transformation that uses the background image.

In response to receiving the second request 116, the video processing instructions 202 add the target transformation 106 to the applicable set of transformations 110.

The video processing instructions 202 apply the applicable set of transformations 112 to the video stream 112.

The video processing instructions 202 further transmit the video stream 112 to the video-controlling device 204 for distribution to other devices, compositing, and/or display.

In this way a transformation may be added or removed from the applicable set of transformations 110, so that the video processing instructions 202 apply a combination of transformations that is desired or expected by the video-controlling device 204.

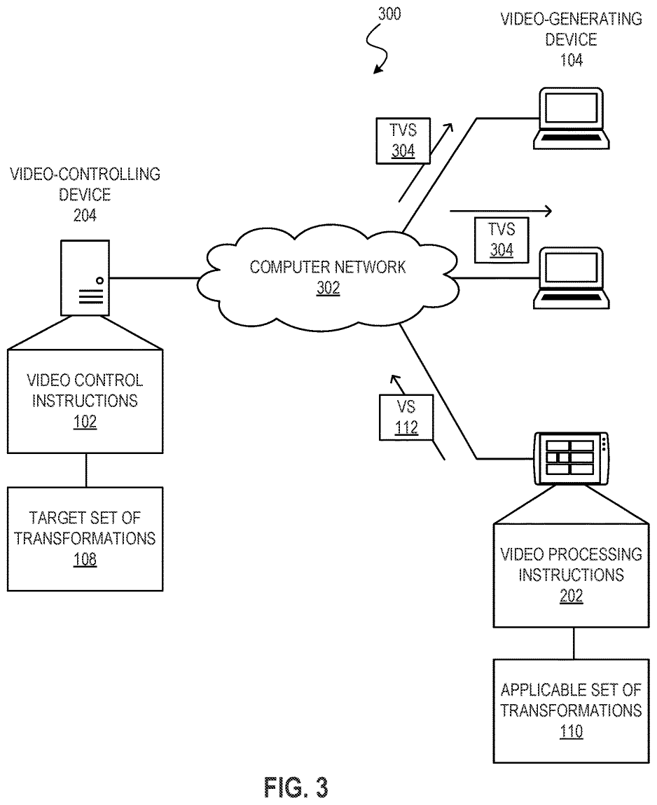

FIG. 3 is a diagram of an example computer system 300 to negotiate a set of transformations 110 for video streams 112 generated by video-generating devices 104. The description above for FIGS. 1 and 2 may be referenced for details not repeated here.

A plurality of video-generating devices 104 may be connected to a video-controlling device 204 via a computer network 302. In various examples, the plurality of video-generating devices 104 are participating in a video conference via the video-controlling device 204. The video-controlling device 204 may be a conference-room computer that distributes, composites, and/or displays the video streams 112 captured from the video-generating devices 104. The video streams 112 may be composited together in one view. For example, each video-generating device 104 may capture the respective user's face and the video-controlling device 204 may composite the faces into a single window. The video-controlling device 204 may distribute the composite video to the video-generating devices 104 for display. Additionally or alternatively, the video-controlling device 204 may display the composite video to users at the location of the video-controlling device 204.

Each video-generating device 104 may capture a video stream 112 and transmit the video stream 112 to the video-controlling device 204.

The video-generating device 104 may execute video processing instructions 202 to apply an applicable set of transformations 110 to the video stream 112.

The video-controlling device 204 may execute video control instructions 102 to request that a target set of transformations 108 be applied to the video streams 112 captured by the video-generating devices 104.

The video-controlling device 204 and each video-generating device 104 participate in a negotiation via communicated requests and indications to match the respective applicable set of transformations 110 to the target set of transformations 108.

Each video-generating device 104 may add or remove any suitable number of transformations from its applicable set of transformations 110 to match the target set of transformations 108. If a particular transformation is unavailable at the video-generating device 104, the video control instructions 102 may apply the particular transformation at the video-controlling device 204. This may be done if the instructions for the transformation are not installed at the video-generating device 104 or if the resources of the video-generating device 104 are insufficient to perform the transformation effectively.

The video-controlling device 204 may then distribute a transformed video stream 304 to the video-generating devices 104. In various examples, each video-generating device 104 provides a respective video stream 112 and receives and displays the transformed video stream 304, which may be a composite of the video streams 112 with a consistent set of transformations applied.

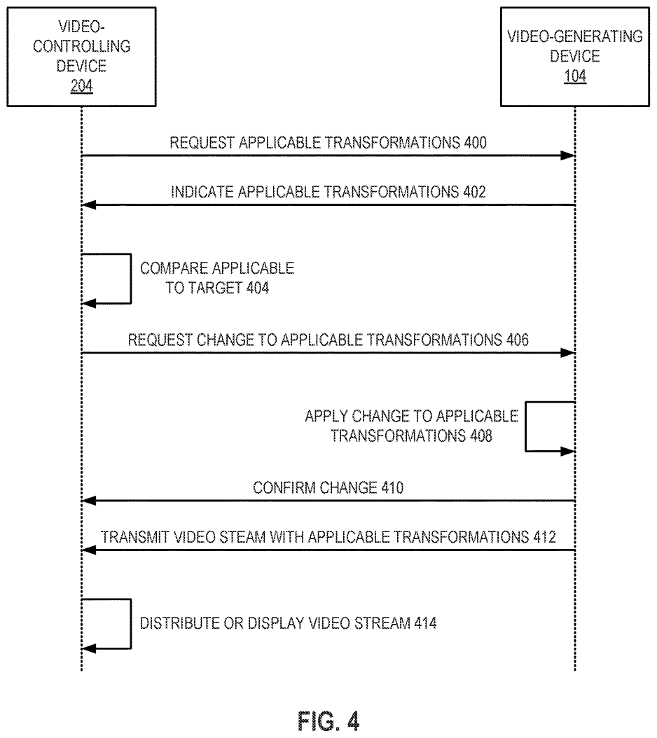

FIG. 4 shows example communications between a video-controlling device 204 and a video-generating device 104 to conform applicable video-stream transformations to target transformations.

The description above for FIGS. 1 and 2 may be referenced for details not repeated here.

The video-controlling device 204 requests applicable transformations 400 from the video-generating device 104. The applicable transformations are those transformations that are currently applied or that will be applied to a video stream generated by the video-generating device 104.

The video-generating device 104, in response, indicates the applicable transformations 402. This may include communicating descriptors, names, or other metadata that identify the transformations.

The video-controlling device 204 then compares the applicable transformations to target transformations 404 to determine whether the applicable transformations match the target transformations. The comparison may identify any target transformations that are missing from the applicable transformations and may identify any applicable transformations that are not part of the target transformations.

The video-controlling device 204 then requests a change to the applicable transformations 406. This may include adding a missing target transformation to the applicable transformations or removing an extraneous transformation from the applicable transformations. A request may indicate any number and type of transformations to add and remove.

The video-generating device 104 applies the requested change to the applicable transformations 408 by adding or removing a transformation.

The video-generating device 104 may then confirm the change 410 with the video-controlling device 204. This may include indicating again the applicable transformations (see 402).

The video-generating device 104 may then capture or continue to capture the video stream, apply the applicable transformations to the video stream, and transmit the transformed video stream 412 to the video-controlling device 204.

The video-controlling device 204 may then distribute or display the transformed video stream 414. This may include compositing the video stream with other video streams received from other video-generating devices 104.

The above communications may be performed between the video-controlling device 204 and multiple video-generating devices 104 with reference to the same set of target transformations, so as to harmonize respective applicable sets of transformations with the target set of transformations. As such, the video-controlling device 204 may display combine video streams from multiple video-generating devices 104 with a consistent appearance.

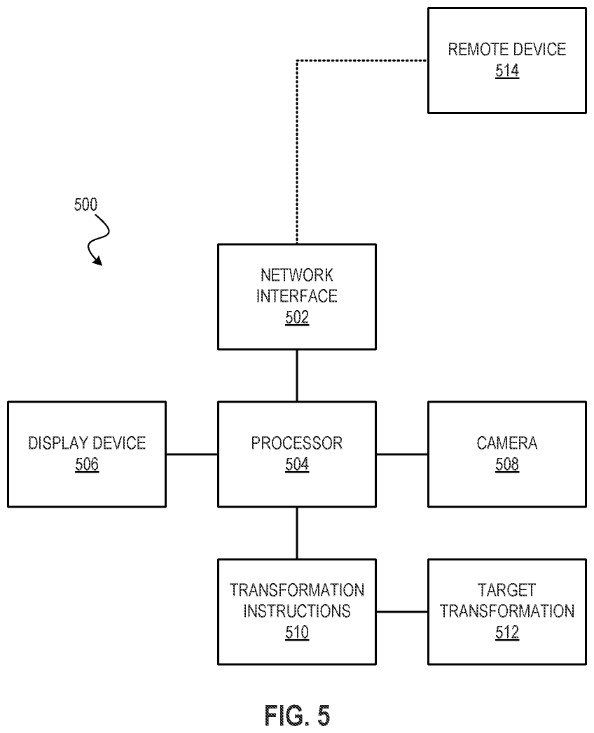

FIG. 5 shows a device 500 to communicate with a remote device 514 to apply a target transformation 512 to a video stream depending on an availability of the target transformation 512 at the remote device 514.

The device 500 includes a network interface 502 and a processor 504 connected to the network interface 502.

The network interface 502 may include a network adapter and driver to enable communications via a wired or wireless computer network (e.g., computer network 302 of FIG. 3), such as a local-area network (LAN), wide-area network (WAN), or the internet.

The processor 504 may be a CPU, a FPGA, an ASIC, or a similar processing device.

The device 500 may further include a display device 506 and a camera 508. The device 500 may be a video-controlling device when provided with a display device 506. The device 500 may be a video-generating device when provided with a camera 508. The device 500 may provide both video capture and video display functionality when provided with both the display device 506 and the camera 508.

The device 500 may be an endpoint in a video communication. The device 500 may be a bidirectional endpoint in that the device 500 both captures and displays video streams. In some examples, the device 500 may be a unidirectional endpoint that captures and does not display video (e.g., a standalone camera) or that displays and does not capture video (e.g., a standalone display screen).

The camera 508 captures a video stream at the location of the device 500 for communication to the remote device 514. The display device 506 plays a video stream received from the remote device 514.

The processor 504 may execute transformation instructions 510 that implement a target transformation 512 on a video stream.

The transformation instructions 510 may communicate with the remote device 514 via the network interface 502 to determine whether a target transformation 512 for a video stream is available at the remote device 514. The video stream may be either or both of a video stream captured by the device 500 or captured by the remote device 514.

If the target transformation 512 is available at the remote device, the transformation instructions 510 communicate with the remote device 514 via the network interface 502 to initiate performance of the target transformation 512 on the video stream at the remote device 514.

If the target transformation 512 is unavailable at the remote device, transformation instructions 510 initiate performance of the target transformation 512 on the video stream at the device 500.

The target transformation 512 may be considered available at the remote device 514 when the remote device 514 indicates that the remote device 514 includes instructions to perform the target transformation 512. That is, availability may be contingent on installation of the target transformation 512.

Target transformation 512 may be considered available at the remote device 514 when the remote device 514 indicates that the remote device 514 has available processing resource capacity to perform the target transformation 512. For example, even if the target transformation 512 is installed, the remote device 514 may not have sufficient resources available to carry out the target transformation 512.

In various examples, the device 500 may be a conference-room computer, such desktop computer or server, that communicates with multiple remote devices 514 that are user computers, such as notebook computers, tablet computers, smartphones, and the like. For example, the device 500 may be the video-controlling device 204 (FIG. 3) and remote devices 514 may be video-generating devices 104 (FIG. 3). The device 500 may request that a target set of transformations be applied by the remote devices 514. For any remote device 514 that is incapable of performing a target transformation (e.g., the transformation is not installed or the remote device lacks sufficient processing power), the device 500 may perform such target transformation on behalf of the incapable remote device 514.

It should be recognized that features and aspects of the various examples provided above can be combined into further examples that also fall within the scope of the present disclosure. In addition, the figures are not to scale and may have size and shape exaggerated for illustrative purposes.

1. A non-transitory computer-readable medium comprising instructions that, when executed by a processor, cause the processor to:
receive an indication of an applicable set of transformations for a video stream captured by a video-generating device;
compare the applicable set of transformations to a target set of transformations to be applied to the video stream to determine if a target transformation absent from the applicable set of transformations exists in the target set of transformations;
when determining that the target transformation exists, transmit a request to the video-generating device to apply the target transformation; and
receive the video stream from the video-generating device with the applicable set of transformations applied.

2. The non-transitory computer-readable medium of claim 1, wherein the instructions are further to cause the processor to:
receive an indication from the video-generating device that the target transformation is included in the applicable set of transformations.

3. The non-transitory computer-readable medium of claim 1, wherein the instructions are further to cause the processor to:
compare the applicable set of transformations to the target set of transformations to be applied to the video stream to determine if an applicable transformation absent from the target set of transformations exists in the applicable set of transformations; and
when determining that the applicable transformation exists, transmit a request to the video-generating device to halt the applicable transformation.

4. The non-transitory computer-readable medium of claim 1, wherein the instructions are further to cause the processor to:
transmit respective requests to respective video-generating devices to apply respective target transformations to harmonize respective applicable sets of transformations with the target set of transformations.

5. The non-transitory computer-readable medium of claim 1, wherein the instructions are further to cause the processor to play the video stream.

6. A non-transitory computer-readable medium comprising instructions that, when executed by a processor, cause the processor to:
capture a video stream;
in response to a first request from a video-controlling device for an applicable set of transformations to be applied to the video stream, transmit an indication of the applicable set of transformations to the video-controlling device;
in response to receiving a second request from the video-controlling device to apply a target transformation, add the target transformation to the applicable set of transformations;
apply the applicable set of transformations to the video stream; and
transmit the video stream to the video-controlling device.

7. The non-transitory computer-readable medium of claim 6, wherein the instructions are further to receive the first and second requests via a computer network.

8. The non-transitory computer-readable medium of claim 6, wherein the instructions are further to transmit an indication of a capability to perform the target transformation to the video-controlling device.

9. The non-transitory computer-readable medium of claim 6, wherein the instructions are further to:
receive a parameter of the target transformation from the video-controlling device; and
apply the target transformation according to the parameter.

10. The non-transitory computer-readable medium of claim 6, wherein the instructions are further to:
receive a background image for the target transformation from the video-controlling device; and
apply the target transformation using the background image.

11. A device comprising:
a network interface; and
a processor connected to the network interface, the processor to:
communicate with a remote device via the network interface to determine whether a target transformation for a video stream is available at the remote device;
if the target transformation is available at the remote device, communicate with the remote device via the network interface to initiate performance of the target transformation on the video stream at the remote device; and
if the target transformation is unavailable at the remote device, initiate performance of the target transformation on the video stream at the device.

12. The device of claim 11, wherein the processor is further to determine that the target transformation is available at the remote device when the remote device indicates that the remote device includes instructions to perform the target transformation.

13. The device of claim 11, wherein the processor is further to determine that the target transformation is available at the remote device when the remote device indicates that the remote device has available processing resource capacity to perform the target transformation.

14. The device of claim 11, further comprising a camera to capture the video stream.

15. The device of claim 11, further comprising a display device to play the video stream.
